(19) United States
(12) Patent Application Publication
(10) Pub. No.: US 2016/0241405 A1
(43) Pub. Date: Aug. 18, 2016

(54) Method, Apparatus and Computer Program for Issuing User Certificate and Verifying User

(71) Applicant: CRUCIALTEC CO., LTD., Gyeonggi-do (KR)

(72) Inventors: Yu Seok Jeong, Gyeonggi-do (KR); Yong Yeon Cho, Seoul (KR); Hyeong Doo Kim, Seoul (KR)

(21) Appl. No.: 15/042,668

(22) Filed: Feb. 12, 2016

(30) Foreign Application Priority Data
Feb. 13, 2015 (KR) 10-2015-0022229

(51) Int. Cl. H04L 9/32; H04L 29/06

(52) U.S. Cl. CPC H04L 9/3263; H04L 63/0428; H04L 2209/24; H04L 2209/64

(57) ABSTRACT

According to an embodiment of the present invention, a method for issuing a user certificate of a verification server comprises: receiving a user certificate issue request including a user ID from a user terminal; receiving a user public key, a biometric identification replacement code, and hardware identification information generated by the user terminal; and generating a user certificate including the user ID, the user public key, and certificate information; and encrypting the user certificate generated and transmitting it to the user terminal, is provided.

### CROSS-REFERENCE TO RELATED APPLICATION

This application claims the benefit under 35 U.S.C. §119 of Korean Application No. 10-2015-0022229, filed Feb. 13, 2015, which is hereby incorporated by reference in its entirety.

### BACKGROUND

1. Field of the Invention

The present invention relates to a method, an apparatus and a computer program for issuing a user certificate and verifying a user. More specifically, the present invention relates to a method, an apparatus and a computer program allowing verification only by the user itself and in an environment other than a certificate issuance target terminal by validating the electronic signature of the user using a symmetric key generated based on user biometric information replacement code and hardware identification information.

2. Discussion of Related Art

Recently, with the increase in the spread of smart devices, more people are able to purchase products, make wire transfers, subscribe to financial products, make service reservations, etc., without limitations on time and space.

Accordingly, user convenience has increased. However, the number of incidents such as personal information leakage, financial accidents, etc. as a result of device loss, hacking, etc., has increased as well.

In order to solve these problems, methods for verifying the user through an accredited certificate, or encrypting various information transmitted from the user terminal to an external server are used.

However, when using an accredited certificate, the verification process through a certificate is complex. Also, when losing the terminal storing the certificate, financial accidents still may occur, and there is still a possibility that information may leak through hacking. Thus, there are disadvantages in that the accredited certificate may be illegally used by a third party if it acquires an accredited certificate and the password thereof.

Thus, the necessity for developing a new technology that may further improve security while increasing user convenience is on the rise.

### SUMMARY OF THE INVENTION

It is an object of the present invention to provide a method for verifying a user that improves user convenience by not allowing an electronic signature without biometric information of the true user, and not having to input the password.

It is another object of the present invention to provide a method that may further improve security, by not allowing a true electronic signature of the user in an equipment environment other than the certificate issuance target user terminal.

According to an embodiment of the present invention, a method for issuing a user certificate of a verification server, including receiving a user certificate issue request including a user ID from a user terminal; receiving a user public key, a biometric identification replacement code, and hardware identification information generated by the user terminal; generating a user certificate including the user ID, user public key, and certificate information; and encrypting the generated user certificate and transmitting it to the user terminal, is provided.

Encrypting the user certificate may be performed by encrypting a hash function value of the generated user certificate with a private key of the verification server.

The biometric identification replacement code may be a code replacing biometric information of a user recognized within the user terminal.

According to another embodiment of the present invention, a method for being issued a user certificate of a user terminal, including transmitting a user certificate issue request including a user ID to a verification server; generating a biometric identification replacement code by recognizing biometric information of a user when receiving an identification request from the verification server; transmitting user public key obtained after generating a pair of user keys, biometric identification replacement code, and hardware identification information to the verification server; and receiving a user certificate including the user ID, user public key, and certificate information from the verification server, is provided.

According to yet another embodiment of the present invention, a method for verifying a user at a user terminal, including receiving a message requiring an electronic signature from a service server; generating a symmetric key based on the biometric information replacement code generated by recognizing biometric information of a user, hardware identification information and time code; performing a signature by encrypting the message through the symmetric key, and encrypting the message once again through a user private key generated at the time of issuing a user certificate; and validating a signature on the message using a symmetric key generated at a verification server by transmitting the signed message and the user certificate to the service server, is provided.

The step of validating the signature of the message may include performing a signature by encrypting a user certificate received from the user terminal by the service server with a private key of the service server; allowing the verification server to validate a signature on the user certificate with a public key of the service server confirmed through a certificate of the service server by transmitting the signed user certificate from the service server to the verification server together with a certificate of the service server; and validating a signature on the message by allowing the service server to receive a symmetric key generated by the verification server.

A symmetric key may be generated by the verification server based on a user ID confirmed through the user certificate, and stored biometric information replacement code and time code stored by matching with the user ID.

According to yet another embodiment of the present invention, a method for verifying a user at a service server, including transmitting a message requiring an electronic signature to a user terminal; receiving at a user terminal the message signed through a process of double encryption with a symmetric key and a user private key generated based on a biometric information replacement code, hardware identification code and time code together with a user certificate; performing a signature by encrypting the user certificate with a private key of the service server; allowing the verification server to receive a symmetric key generated based on a stored biometric information replacement code, hardware identification information and time code matching with a user ID included in the user certificate by transmitting the signed user certificate to a verification server; and performing the signature validation of the signed message received from the user terminal using the symmetric key received, is provided.

The step of receiving the symmetric key may include allowing the verification server to validate a signature performed by the service server with a public key of a service server confirmed through a certificate of the service server by transmitting the signed user certificate and the certificate of the service server to a verification server.

According to yet another embodiment of the present invention, a method for verifying a user at a verification server, including receiving the user certificate signed using a private key of a service server from the service server receiving the message signed through a symmetric key and user private key, and user certificate from a user terminal; confirming a public key of a service server through a certificate of a service server received together with the signed user certificate, and performing the signature validation of the user certificate with a public key of the confirmed service server; generating a symmetric key based on a stored biometric information replacement code, hardware identification information and time code matching with a user ID confirmed through the user certificate; and performing the signature validation of the message by transmitting the generated symmetric key to the service server, is provided.

According to an embodiment, since an electronic signature cannot be made without biometric information of the true user, security can be improved as compared with methods such as inputting the password, etc., and user convenience may be improved because the password does not have to be input.

Also, according to an embodiment, since it is determined whether the electronic signature of the user is valid using a symmetric key generated based on hardware identification information, security can be improved by not allowing a signature to be made with equipment other than the certificate issuance target user terminal.

### BRIEF DESCRIPTION OF THE DRAWINGS

FIG. 1 is a drawing illustrating a system for issuing a user certificate and verifying a user according to an embodiment of the present invention;

FIG. 2 is a flow chart for explaining the process for issuing a user certificate according to an embodiment of the present invention;

FIG. 3 is flow chart for explaining the process for verifying a user according to an embodiment of the present invention;

FIG. 4 is a flow chart for explaining the process for verifying a user according to another embodiment of the present invention;

FIG. 5 is a block diagram for functionally explaining the inner constitution of a user terminal according to an embodiment of the present invention;

FIG. 6 is a block diagram for functionally explaining the inner constitution of a verification server according to an embodiment of the present invention;

FIG. 7 is a block diagram for functionally explaining the inner constitution of a service server according to an embodiment of the present invention;

FIG. 8 is a table illustrating information stored and transmitted in each constituent in the process for issuing a user certificate according to an embodiment of the present invention; and

FIGS. 9 and 10 are tables illustrating information stored and transmitted in the process of verifying a user according to an embodiment of the present invention.

### BEST MODE FOR CARRYING OUT THE INVENTION

Hereinafter, the present invention will be explained with reference to the accompanying drawings. The present invention, however, may be modified in various different ways, and should not be construed as limited to the embodiments set forth herein. Also, in order to clearly explain the present invention, portions that are not related to the present invention are omitted, and like reference numerals are used to refer to like elements throughout.

Throughout the specification, it will be understood that when an element is referred to as being “connected to” another element, it may be “directly connected to” the other element, or intervening elements or layers may be present. Also, it will also be understood that when a component “includes” an element, unless stated otherwise, it should be understood that the component does not exclude other elements.

Hereinafter, examples of the present invention will be explained in more detail with reference to the accompanying drawings.

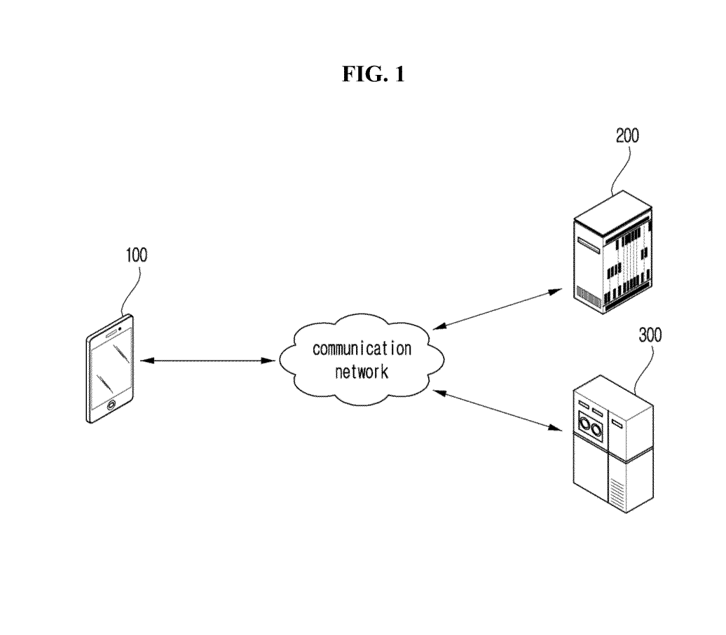

FIG. 1 is a drawing illustrating a system for issuing a user certificate and verifying a user according to an embodiment of the present invention.

Referring to FIG. 1, the bio verification system according to an embodiment may include a user terminal 100, a verification server 200, and a service server 300 communicating with one another through a communication network. Hereinafter, for convenience, it will be assumed that a verification server 200 and a service server 300 are implemented separately. However, the verification server 200 and service server 300 may be implemented as one server to perform both functions.

A user terminal 100 according to an embodiment is a device in communication with a verification server 200 and a service server 300, such as a telephone, a cell phone, a smartphone, a personal digital assistant (PDA), a tablet, etc., which is capable of communicating using a communication network such as a wired communication network, 3G, LTE, etc. provided by an operator, and may include a device having a calculation function. The user terminal 100 may be implemented with a computer operated through a computer program for realizing the function explained in the specification.

A user terminal 100 may have a user certificate issued through a communication with a verification server 200. The user certificate issued may include a user ID, a public key generated at the user terminal 100, certificate information, etc. When issuing a user certificate, biometric information replacement code of the user is transmitted from the user terminal 100 to the verification server 200, and stored. The biometric information replacement code is generated based on biometric information of the user obtained by the user terminal 100.

Meanwhile, the user terminal 100 may receive a message requiring an electronic signature request from the service server 300, and transmit this to the service server 300 after electronic signature. As described below, an electronic signature on the message may be performed by a process of double encryption through a symmetric key and a user private key generated by the user terminal 100.

The user terminal 100 has hardware identification information for each piece of equipment. In this regard, according to an embodiment of the present invention, the symmetric key is generated based on information including hardware identification information. Thus, when validating a signature on a message, hardware identification information is validated as well. Thus, it becomes impossible to make an electronic signature based on the previously issued user certificate on another piece of equipment, and thus security can be improved.

The verification server 200 performs the function for issuing a user certificate of a user terminal 100. The verification server 200 may be a server managed by being verified by a predetermined highest authorization authority (not shown). The verification server 200 issues the user certificate by going through a procedure of confirming identity according to the user certificate issue request transmitted from the user terminal 100. During the process of issuing the user certificate, a key pair is generated in the user terminal 100. Among them, a private key may be stored in the user terminal 100 and a public key may be stored in the verification server 200. Also, when issuing the user certificate, biometric information replacement code and hardware identification information are received from the user terminal 100. Accordingly, the verification server 200 may store user ID, biometric information replacement code, hardware identification information matching with each user. The verification server 200 may be implemented with a computer operated through a computer program for realizing the function explained in the specification.

After the service server 300 transmits a message requiring an electronic signature to the user terminal 100, upon receiving the electronically signed message, the user certificate received from the corresponding user terminal 100 is signed, and then transmitted to the verification server 200 together with a certificate of the service server 300. In this case, it is assumed that the service server 300 receives the certificate of the service server 300 by the verification server 200 and that the verification server 200 stores the certificate of the service server 300 in accordance with basic information on the service server 300. After the verification server 200 validates the signature signed by the service server 300, the verification server 200 identifies the user through a user certificate, and after generating a symmetric key explained in the above, the generated symmetric key is transmitted to the service server 300. The service server 300 may validate the signature on the message performed by the user terminal 100 with the symmetric key.

The service server 300 is a server providing predetermined service to the user terminal 100. For example, it may be a payment relaying server, a verification relating server or a server providing other services. The service server 300 may be implemented with a computer operated through a computer program for realizing the function explained in the specification.

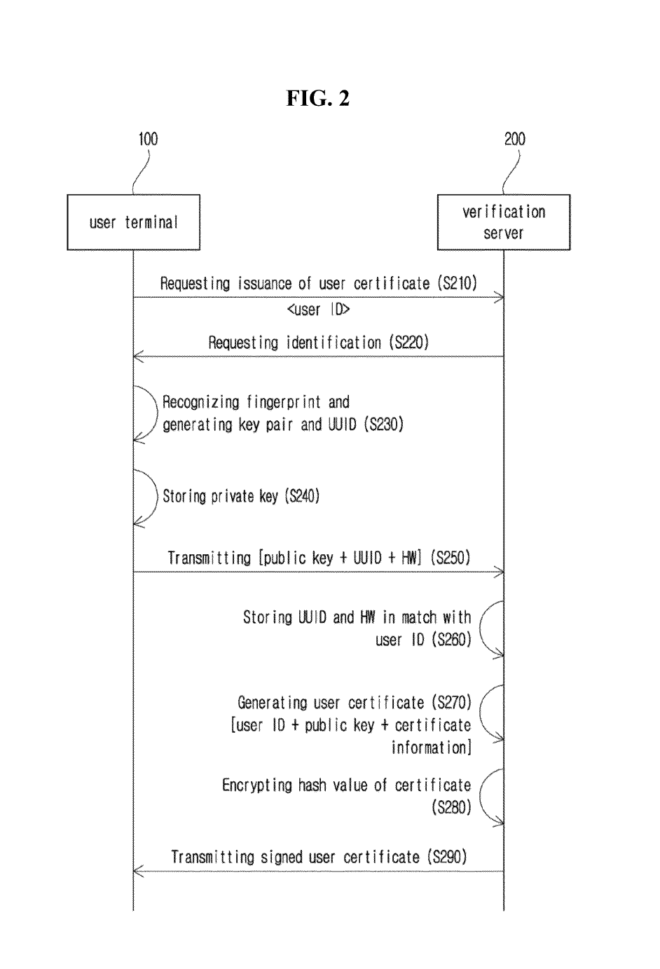

FIG. 2 is a drawing explaining the procedure for issuing a user certificate according to an embodiment of the present invention. In this case, it is assumed that the verification server 200 is managed by being verified by a predetermined highest authorization authority (not shown). The service server 300 issues the certificate of the service server 300 by the verification server 200, and the verification server 200 stores the certificate of the service server 300 in accordance with basic information on the service server 300.

Also, it is assumed that data is communicated between the user terminal 100 and verification server 200, and verification server 200 and service server 300 by encrypting and decrypting data with their unique session key.

Referring to FIG. 2, a user certificate issue request is transmitted from the user terminal 100 to the verification server 200 according to the operation of the user (S210). Before the step of transmitting a user certificate issue request, a process of performing an application for issuing a user certificate according to an embodiment of the present invention may be further performed in the user terminal 100. This application may be installed together with the operating system in the user terminal 100, but it may also be developed and distributed by the verification server 200 operator or service server 300 operator so that it can be downloaded and installed in the user terminal 100 through an application store server (not shown).

When requesting for user certificate issue in step S210, the user ID may be transmitted together.

According to an embodiment, before issuing a certificate, the user can register a user ID by visiting a financial institution. In this case, the corresponding user ID may be transmitted to the verification server 200 and pre-stored. Meanwhile, according to another embodiment, the user may register a user ID before issuing a user certificate by going through the on-line sign in procedure through an application for issuing a user certificate installed in the user terminal 100. Even by this method, the user ID may be pre-stored in the verification server 200. In addition, the user may set a user ID before issuing a user certificate through various methods.

By transmitting the user ID to the verification server 200 at the time of requesting for user certificate issue from the user terminal 100, the verification server 200 may identify the corresponding user by comparing the user ID pre-stored with the user ID transmitted.

The user ID may be transmitted in encrypted format with a session key. In this regard, the session key may be referred to as a temporary encryption key used only during one communication session between the two parties.

A verification server 200 receiving a user certificate issue request including a user ID transmits an identity confirmation request to the user terminal 100 (S220).

The user terminal 100 receiving an identity confirmation request activates the function for obtaining biometric verification information for identity confirmation. Biometric verification information may be verification information such as fingerprints, iris, retina, etc. The function for obtaining biometric verification information may be activated by calling a second application capable of obtaining biometric verification information from a first application for issuing a user certificate, and the corresponding technology may be activated in the first application. For example, in order to recognize biometric information, the user terminal 100 may include a biometric recognizing sensor (110; see FIG. 1).

Biometric verification information may be obtained from the user terminal 100 and, in addition thereto, a user key pair and biometric information replacement code, e.g., a universally unique identifier (UUID) may be generated in the user terminal 100 (S230). When generating a user key pair and biometric information replacement code, hardware identification information may be further generated. The user key pair means a private key and public key of the user. Biometric information replacement code is a value converting the recognized biometric information to a unique code without transmitting it outside the user terminal 100. Meanwhile, hardware identification information may be in any known form as identification information of the user terminal 100 itself.

With regard to the user key pair generated, the private key is stored in the user terminal 100 (S240), and the user public key, biometric information replacement code and hardware identification information (HW) are encrypted with a session key and transmitted to the verification server 200 (S250).

The verification server 200 stores biometric information replacement code and hardware identification information together in the user information having the corresponding user ID (S260).

Then, the verification server 200 generates a user certificate based on the corresponding user ID, public key and certificate information (S270). In addition to the above information, the user certificate may further include information on the issuing authority of the certificate and other information (e.g., expiration date of the certificate, etc.), etc.

The verification server 200 generates a hash value using a hash algorithm having the user certificate generated as a seed value, and after encrypting the hash value with the private key of the verification server 200 (S280), the hash value is transmitted to the user terminal 100 (S290). When referring to the process of converting the user certificate into a hash value and encrypting it with a private key as “signing,” step S290 may be explained as a process where the signed user certificate is transmitted from the verification server 200 to the user terminal 100. The user certificate signed in step S290 may be encrypted with a session key and transmitted. Accordingly, the process of issuing a user certificate may be completed.

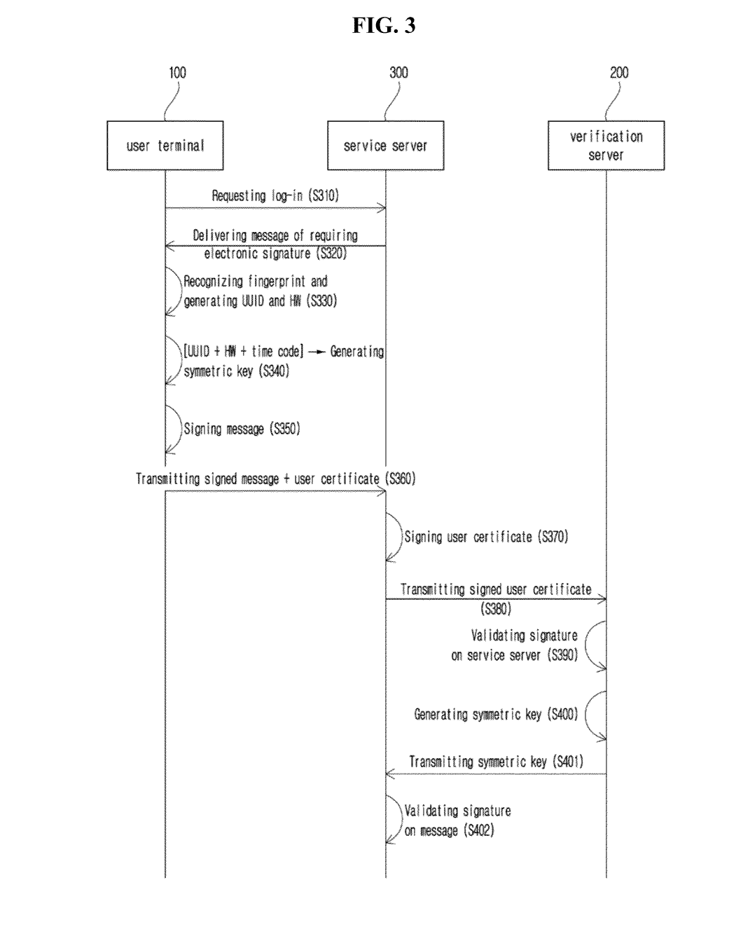

FIG. 3 is a drawing for explaining an example of using a user certificate issued according to the process illustrated in FIG. 2. In this case, it is assumed that the verification server 200 is managed by being verified by a predetermined highest authorization authority (not shown). It is assumed that the service server 300 issues a certificate of the service server 300 by a verification server 200, and the verification server 200 stores the certificate of the service server 300 in accordance with basic information on the service server 300. Also, it is assumed that data is communicated between the user terminal 100 and verification server 200, verification server 200 and service server 300 by encrypting and decrypting data with their unique session key.

Referring to FIG. 3, first, a log-in request is transmitted from the user terminal 100 to the service server 300 (S310). The user may use services such as electronic business transaction, log-in, etc. based on identity verification of various authorities through the user terminal 100. In this case, the user should go through an identity verification process for paying costs. At this time, the user may transmit a log-in request to the service server 300 for identity verification. For example, the service server 300 may be a payment relaying server operated by a payment relaying company.

The service server 300 receiving a log-in request may deliver a message that an electronic signature is required to a user terminal 100 (S320). The message may be a message asking for the user's approval, and may be a message requiring an electronic signature of the user in this regard. The corresponding message may be encrypted with a session key and transmitted.

A function for obtaining biometric information is activated in the user terminal 100 receiving a message requiring an electronic signature. A separate application may be activated for obtaining biometric information, and the function for obtaining biometric information may be activated within a user interface activated to communicate with the service server 300. The function for obtaining biometric information may be activated automatically, but it may also be activated by having a user turn on the corresponding function through a user terminal 100.

Biometric information of the user is obtained through the function for obtaining biometric information activated in the user terminal 100, and through this, biometric information replacement code (UUID) and hardware identification information (HW) are generated (S330). In this case, a time code may be generated based on the time they are generated. The biometric information recognized may be compared with the pre-registered biometric information to confirm whether the user is a true user.

Biometric information replacement code, hardware identification information and time code generated are mixed and generated as a symmetric key (S340).

After generating a hash value of the message based on the message received in step S320, the user terminal 100 encrypts it with a symmetric key generated in step S340, and further encrypts it again with a user private key (S350). Since the user private key is stored in the user terminal 100 during the process of issuing a user certificate explained with reference to FIG. 2, the message may be encrypted using this. When referring to the process of generating a hash value of the message, and then encrypting it with a symmetric key and a user private key, i.e., the process of encrypting the message twice, as “signing,” step S350 may be referred to as a process of signing a message received from the service server 300.

When the signature on a message is completed, together with the signed message and user certificate, it is encrypted with a session key and transmitted to the service server 300 (S360).

The service server 300 signs a user certificate transmitted from the user terminal 100 (S370). The signature here may include the process of encrypting the user certificate with a private key of the service server 300.

The service server 300 transmits the signed user certificate to the verification server 200 (S380). During step S380, together with the user certificate, a certificate of the service server 300 may be encrypted with a session key and transmitted. As assumed above, the certificate of the service server 300 is issued by the verification server 200 and stored in the service server 300. In this regard, it may be issued by the same process of issuing a user certificate explained with reference to FIG. 2. Transmitting in step S380 may be performed after encryption with a session key.

The verification server 200 identifies the service server 300 transmitting the corresponding certificate through a certificate of the service server 300 among the information transmitted from the service server 300, and validates the signature of the service server 300 on the user certificate transmitted in step S380 with a public key of the service server 300 (S390). By confirming certificate information of the service server 300 with a public key of the verification server 200, the public key of the service server 300 may be confirmed. The public key of the service server 300 is included in the corresponding certificate when issuing the certificate of the service server 300 on the service server 300.

When signature validation on the service server 300 is completed, the verification server 200 generates a symmetric key in the same manner as explained in step S340 (S400). Since the verification server 200 stores biometric information replacement code, and hardware identification information of user terminal 100 matching with user ID during the process of issuing a user certificate explained with reference to FIG. 2, a symmetric key may be generated through this. Specifically, by performing signature validation on the user certificate transmitted in step S380 and signed by the service server 300, information on the user certificate may be confirmed. In this regard, since user ID is included in information on the user certificate, stored biometric information replacement code and hardware identification matching with the corresponding user ID may be extracted and a symmetric key is generated by combining this with a time code.

The symmetric key generated is transmitted to the service server 300 (S401). During transmission, it may be encrypted with a session key and transmitted.

The service server 300 may perform signature validation on a signed message transmitted from the user terminal 100 through a symmetric key transmitted (S402). Since a message in the user terminal 100 is signed by encrypting the message with a symmetric key and further encrypting it with a private key, the service server 300 may validate the signature on a message with a symmetric key obtained and a public key of the user included in the user certificate. In the case of a true user, since the symmetric key generated in the user terminal 100 would be the same as the symmetric key generated in the verification server 200, signature validation would be successful. If not, signature validation would be determined as a failure, and a corresponding operation would be performed (for example, retrial message would be displayed, or a message that the certificate has expired or the user is not a true user would be displayed). Identification of the corresponding user may be performed through user ID information included in the user certificate received in step S360.

As mentioned above, the message may be a message asking for the user's approval, which requires an electronic signature of the user. If the signature on the user is validated through the above process, it may be determined whether the corresponding message is true.

According to the electronic signature method, it is not possible to make a signature without biometric recognition on the true user and the biometric information replacement code based thereon. Thus, security can be improved as compared with the method of inputting a password, etc.

Also, since a symmetric key generated based on hardware identification information is used when validating the signature, it becomes impossible to make a signature with equipment other than the user terminal 100, which is the certificate issuance target.

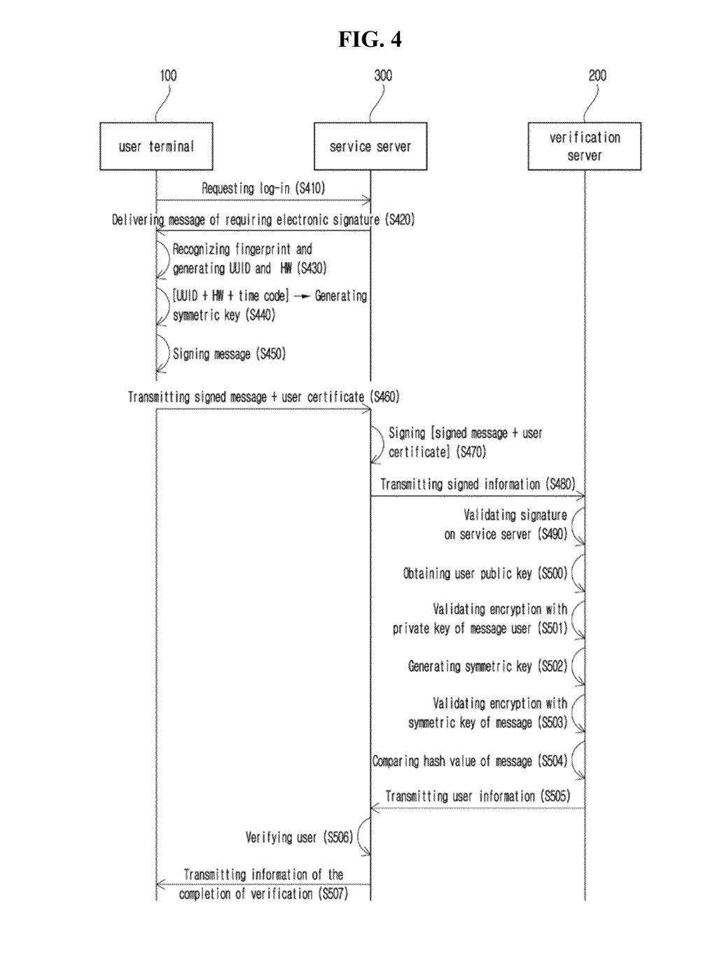

FIG. 4 is a drawing for explaining an example of the process of using a user certificate according to another embodiment of the present invention. For convenience, only the differences from FIG. 3 will be focused on.

Referring to FIG. 4, first, a log-in request is transmitted from a user terminal 100 to a service server 300 (S410). The process of delivering a message that the service server 300 requires an electronic signature to the user terminal 100 (S420) is the same as the process illustrated in FIG. 3.

The function for obtaining biometric information is activated in the user terminal 100 receiving a message requiring an electronic signature. Biometric information on the user is obtained through the function for obtaining activated biometric information, and through this, biometric information replacement code (UUID) and hardware identification information (HW) are generated (S430).

The biometric information replacement code and hardware identification information generated are mixed and generated with a symmetric key (S440).

After generating a hash value of the message received in step S420 using a hash algorithm, it is encrypted with a symmetric key generated in step S440, and further encrypted with a user private key (S450). That is, a signature is performed on a message received from the service server 300.

When the signature on the message is completed, together with the signed message and user certificate, it is encrypted with a session key and transmitted to the service server 300 (S460).

The service server 300 signs by bundling up the signed message transmitted from the user terminal 100 and user certificate as one information (S470). The signature here may include the process of encrypting with a private key of the service server 300.

The service server 300 transmits the signed result to the verification server 200 (S480). A certificate of the service server 300 may be transmitted together in step S480, and the transmitted information may all be encrypted with a session key and transmitted.

The verification server 200 identifies the service server 300 transmitting the corresponding certificate through a certificate of the service server 300 among the information transmitted from the service server 300, and validates the signature information on the service server 300 transmitted in step S480 with a public key of the service server 300 (S490). That is, the signature performed by the service server 300 in step S470 is validated. By confirming certificate information of the service server 300 with a public key of the verification server 200, the public key of the service server 300 may be confirmed.

When signature validation on the service server 300 is completed, the user certificate is confirmed with a public key of the verification server 200 among the information transmitted in step S480, to obtain a user public key (S500).

When a user public key is obtained, the signature performed in the user terminal 100 may be validated through this. Since the signature in the user terminal 100 goes through the process of encrypting with a symmetric key and further encrypting again with a user private key, first the encryption process through a user private key is validated through the user public key (S501).

Then, the verification server 200 generates a symmetric key in the same manner as the process explained in step S440 (S502). Since the verification server 200 stores biometric information replacement code and hardware identification information of the user terminal 100 matching with the user ID during the process of issuing a user certificate explained with reference to FIG. 2, a symmetric key may be generated through this. The process of generating a symmetric key may be performed before or simultaneously with step S501.

The verification server 200 performs validation on symmetric key encryption, which is the first encryption process in signing in the user terminal 100 through the symmetric key generated (S503).

The signature on the message performed in the user terminal 100 may be validated through steps S501 and S503. Specifically, since the message is encrypted twice with a symmetric key and user private key, signature validation on a message may be completed by validating twice with a user public key and symmetric key.

The value obtained by completing signature validation is a hash value. This is because signature target in the user terminal 200 is the hash value of the message.

Thus, the verification server 200 generates a hash value of the message by itself, and compares it with the hash value of the message obtained through steps S501 and S503 (S504).

After comparison, when they are confirmed to be the same, the signature in the user terminal 100 is determined to be true, and validation is completed. After completing validation, the verification server 200 delivers user information pre-stored to the service server 300 (S505). The user information is information stored in the verification server 200 matching with user ID. User information may be transmitted after being encrypted with a session key.

After the service server 300 finally performs verification on a user through the user information received, user verification is completed (S506).

Information that user verification is successfully completed may be transmitted from the service server 300 to the user terminal 100.

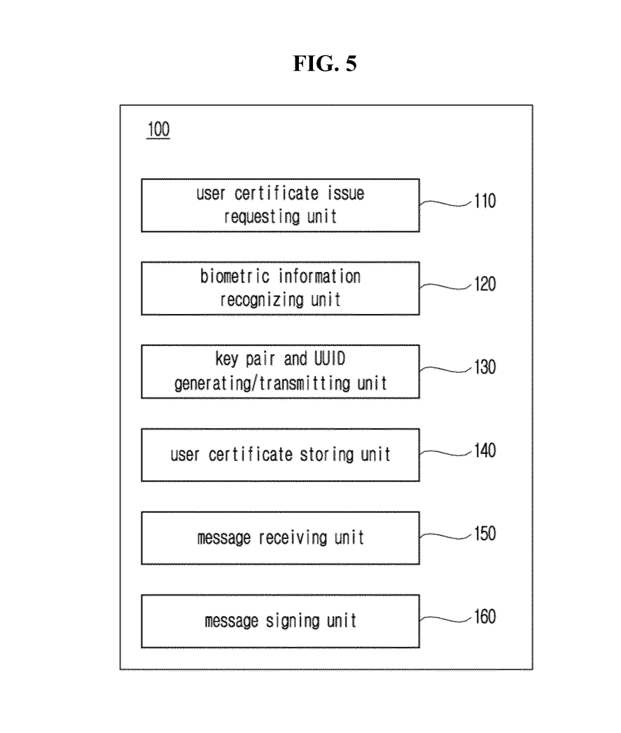

FIG. 5 is a block diagram for explaining the function of the inner constitution and each constitution of the user terminal 100 according to an embodiment of the present invention.

Referring to FIG. 5, the user terminal 100 according to an embodiment may include a user certificate issue request unit 110, a biometric information recognizing unit 120, a key pair and UUID generating/transmitting unit 130, a user certificate storing unit 140, a message receiving unit 150, and a message signing unit 160.

According to an embodiment of the present invention, the user certificate issue request unit 110, biometric information recognizing unit 120, key pair and UUID generating/transmitting unit 130, user certificate storing unit 140, message receiving unit 150, and message signing unit 160 may be computer program modules or hardware capable of communicating with external devices. The program module or hardware may be included in the user terminal 100 or other devices communicating with it in the form of an operating system, an applied program module and other program module, and physically, it may be stored in various known memory devices. Meanwhile, the program module or hardware may include a routine, a sub-routine, a program, an object, a component, data structure, etc., performing a specific work or signing a specific abstract type of data that will be discussed below in the present invention, but is not limited thereto.

The user certificate issue request unit 110 performs the function for requesting for issuance of a user certificate at the verification server 200. Upon requesting for issuance of a user certificate, user ID input by the user may be transmitted as well.

The biometric information recognizing unit 120 performs the function for obtaining biometric information on a user upon request of identity confirmation from the verification server 200 after requesting for issuance of the user certificate. The biometric information recognizing unit 120 may be implemented with, for example, a fingerprint sensor, an iris sensing sensor, etc., and may be formed to send biometric information input from the user.

The key pair and UUID generating/transmitting unit 130 performs the function for generating a user private key and public key and transmitting the public key to the verification server 200, while converting biometric information obtained by the biometric information recognizing unit 120 into biometric information replacement code. The user public key, biometric information replacement code and hardware identification information generated may be transmitted to the verification server 200 during the process of issuing the user certificate.

The user certificate storing unit 140 is generated by the verification server 200, and receives a user certificate including a user ID, a user public key and certificate information from the verification server 200 and stores this.

The message receiving unit 150 receives a message requiring an electronic signature from the service server 300, for example, a user approval message.

The message signing unit 160 signs a message transmitted from the service server 300. Specifically, after receiving a message, the biometric information recognizing unit 120 is activated and biometric information on the user is obtained. After generating a symmetric key based on the biometric information replacement code and hardware identification information generated through this, and encrypting the message with the generated symmetric key, the message is encrypted once again with a user private key pre-stored. In the embodiment explained with reference to FIG. 3, in addition to biometric information replacement code and hardware identification information, a time code may be further combined and generated. The message signed by going through the encryption process twice is transmitted to the service server 300.

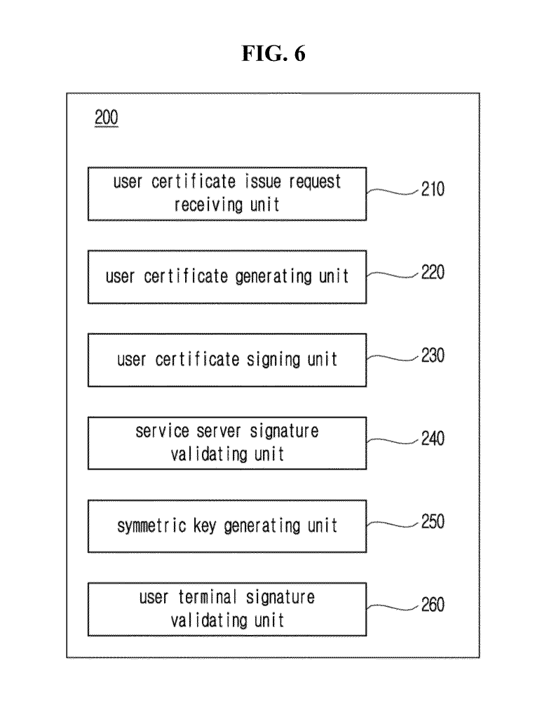

FIG. 6 is a block diagram for explaining the function of the inner constitution and each constitution of the verification server 200 according to an embodiment of the present invention.

Referring to FIG. 6, the verification server 200 according to an embodiment may include a user certificate issue request receiving unit 210, a user certificate generating unit 220, a user certificate signing unit 230, a service server signature validating unit 240, a symmetric key generating unit 250, and a user terminal signature validating unit 260.

According to an embodiment of the present invention, the user certificate issue request receiving unit 210, user certificate generating unit 220, user certificate signing unit 230, service server signature validating unit 240, symmetric key generating unit 250, and user terminal signature validating unit 260 may be computer program modules or hardware capable of communicating with external devices. The program module or hardware may be included in the verification server 200 or other devices communicating with it in the form of an operating system, an applied program module and other program module, and physically, it may be stored on various known memory devices. Meanwhile, the program module or hardware may include a routine, a sub-routine, a program, an object, a component, data structure, etc., performing a specific task or signing a specific abstract type of data that will be discussed below in the present invention, but is not limited thereto.

The user certificate issue request receiving unit 210 receives a user certificate issue request from the user terminal 100, and transmits an identity confirmation request in response thereto. When requesting for issuance of the user certificate, a user ID may be transmitted as well. The process of generating biometric information replacement code and obtaining hardware identification information may be performed in the user terminal 100 receiving identity confirmation request.

The user certificate generating unit 220 generates a user certificate by including information such as user ID, user public key, etc. received from the user terminal 100. The user certificate may include information on the issuing authority of the certificate, i.e., information on the authority operating the verification server 200 and expiration date of the certificate, etc.

The user certificate signing unit 230 signs the user certificate generated by the user certificate generating unit 220. Specifically, it may perform the process of obtaining a hash value of the user certificate generated, and encrypting this with a private key of the verification server 200. Also, it may transmit the user certificate signed through this process to the user terminal 100.

The service server signature validating unit 240 is a part operating while using the user certificate. After the service server 300 receiving the signed message and user certificate from the user terminal 100 performs a signature, when this is transmitted to the verification server 200, the service server signature validating unit 240 validates the signature performed by the service server 300. First, a public key of the service server 300 is confirmed through the certificate of the service server 300, and the signature is validated with the confirmed public key.

After signature validation on the service server 300 is completed, the symmetric key generating unit 250 generates a symmetric key based on stored biometric information replacement code and hardware identification information of the corresponding user matching with the user ID confirmed through the user certificate. When generating a symmetric key, a time code related to the symmetric key generating time may be used as well. When the generation of the symmetric key is completed, the message signed by the user terminal 100 may be validated by transmitting the corresponding symmetric key to the service server 300, and the verification server 200 itself may be used for validating the signature of the message.

The user terminal signature validating unit 260 is a part operating in the embodiment explained with reference to FIG. 4. After signature validation on the service server 300 is completed, it performs the function for validating the signature on the message performed in the user terminal 100 with the symmetric key generated by the user public key and symmetric key generating unit 250 obtained. As a means for validating the signed message transmitted from the service server 300, after obtaining the hash value of the message, final validation on the message signature may be completed by comparing it with the hash value of the message obtained by itself.

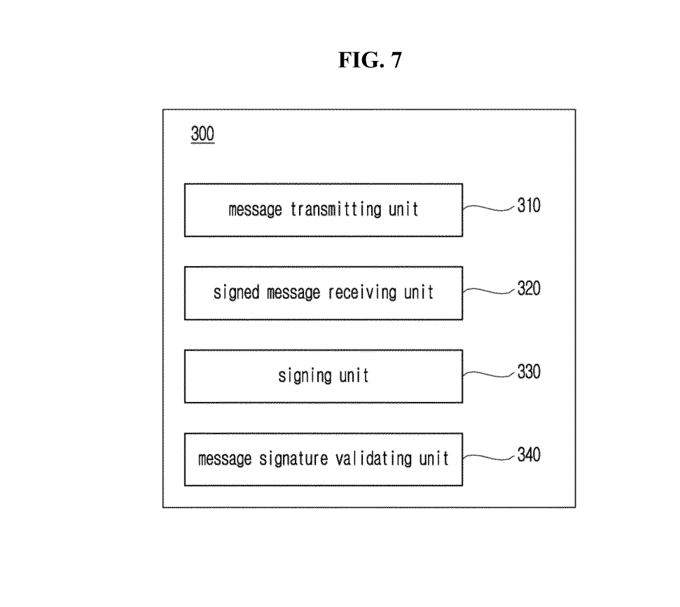

FIG. 7 is a drawing for explaining the function of service server 300 according to an embodiment of the present invention.

Referring to FIG. 7, the service server 300 according to an embodiment may include a message transmitting unit 310, a signed message receiving unit 320, a signing unit 330, and a message signature validating unit 340.

According to an embodiment of the present invention, the message transmitting unit 310, signed message receiving unit 320, signing unit 330, and message signature validating unit 340 may be computer program modules or hardware capable of communicating with external devices. The program module or hardware may be included in the service server 300 or other devices communicating with it in the form of an operating system, an applied program module and other program module, and physically, it may be stored on various known memory devices. Meanwhile, the program module or hardware may include a routine, a sub-routine, a program, an object, a component, data structure, etc., performing a specific task or signing a specific abstract type of data that will be discussed below in the present invention, but is not limited thereto.

The message transmitting unit 310 may perform the function for transmitting a message requiring a signature to the user terminal 100. The transmitted message may be a message requiring the user's approval, and may be a different type of message which needs to receive feedback from the true user after confirming and verifying identity of user.

The signed message receiving unit 320 receives a signed message from the user terminal 100 with regard to a message transmitted by the message transmitting unit 310. The user terminal 100 goes through the signature process of encrypting the message using a symmetric key generated based on biometric identification replacement code, hardware information and time code, and then further encrypting this again through a user private key. The message signed through this process is transmitted to the service server 300. When transmitting the signed message, the user certificate may be transmitted together.

The user certificate signing unit 330 may perform the signature of a user certificate transmitted from a user terminal 100, or perform the signature of a user certificate and signed message. At this time, the signature may be performed through an encryption process using a private key of the service server 300. The private key of the service server 300 may be generated during the process of issuing a certificate of the service server 300 through communication with the verification server 200. The signed information is transmitted to the verification server 200 together with the certificate of the service server 300. The verification server 200 may transmit a symmetric key generated using hardware identification information, biometric information replacement code and time code of the corresponding user to the service server 300 in response thereto.

The message signature validating unit 340 is a part operating in the embodiment explained with reference to FIG. 3. It validates the signed message received from the user terminal 100 through a symmetric key received from the verification server 200. As mentioned above, the signature signed by the user terminal 100 may be validated by the verification server 200.

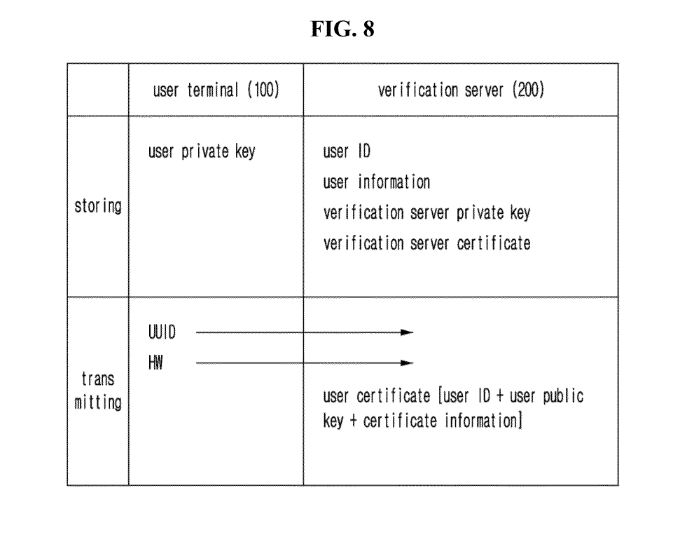

FIG. 8 is a table illustrating information transmitted or stored in each constituent during the process of issuing a user certificate according to an embodiment of the present invention.

Referring to FIG. 8, the verification server 200 includes user database storing information on the user and verification server database storing information on the verification server itself.

According to an embodiment, before the verification server 200 issues a user certificate with a user terminal 100, the user requesting for issuance of a user certificate may register a user ID and provide user information by a visiting financial institution. In this case, the corresponding user ID and user information may be transmitted to the verification server 200 and stored in the user database. Meanwhile, according to another embodiment, the user may register a user ID before issuing a user certificate and input user information by going through the on-line sign in procedure through an application for issuing a user certificate installed in the user terminal 100. In this case, the user ID and user information may be stored in the user database of the verification server 200.

Also, the verification server 200 may store the private key of the verification server, public key of the verification server and certificate of the verification server generated during the process of verification at the database on the verification server itself through a highest authentication authority (not shown).

As explained with reference to S230 and S250 in FIG. 2, the user terminal 100 may transmit and store biometric information replacement code (UUID) and hardware identification information (HW) to the verification server 200, and generate and store a user private key during this process. The verification server 200 generates the user certificate including user ID, user public key transmitted from user terminal 100 and certificate information, etc., and sends it to the user terminal 100.

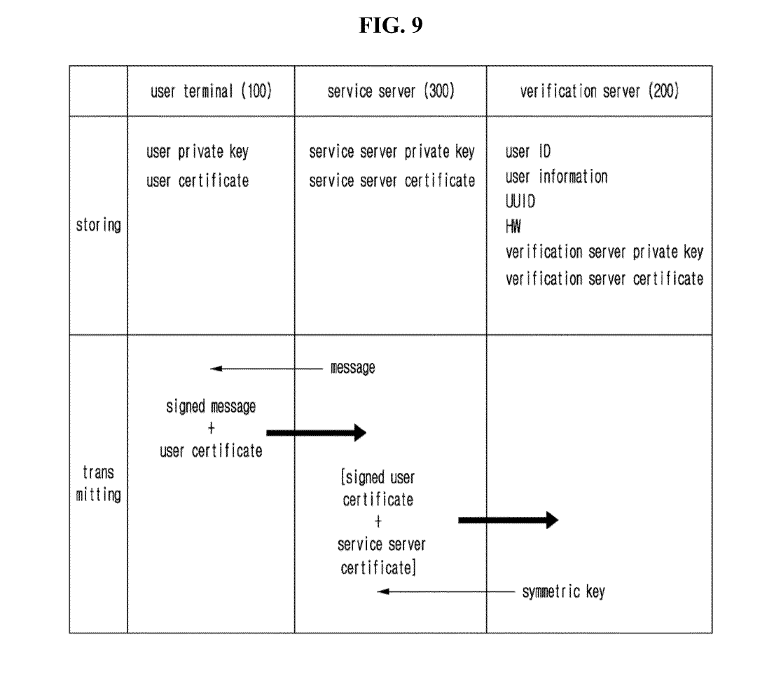

FIG. 9 is a table illustrating information transmitted or stored to each constituent during the process of verifying a user explained with reference to FIG. 3.

Referring to FIG. 9, user terminal 100, verification server 200, and service server 300 always store their private key and certificate. Specifically, the user terminal 100 stores user private key and user certificate, the verification server 200 stores verification server private key and verification server certificate, and the service server 300 stores service server private key and service server certificate. Also, the verification server 200 stores user ID and user information, and it even stores biometric information replacement code (UUID) and hardware identification information (HW) received during the process of issuing user certificate.

The service server 300 transmits a message requiring a signature to the user terminal 100, and after signing the corresponding message, the user terminal transmits it together with the user certificate.

The service server 300 signs the user certificate received from user terminal 100 by itself, and transmits it to the verification server 200 together with the service server certificate.

The verification server 200 generates a symmetric key the same as the symmetric key used during signature at the user terminal 100 and transmits it to the service server 300, so that the service server 300 may validate the signature of the user terminal 100 on the message.

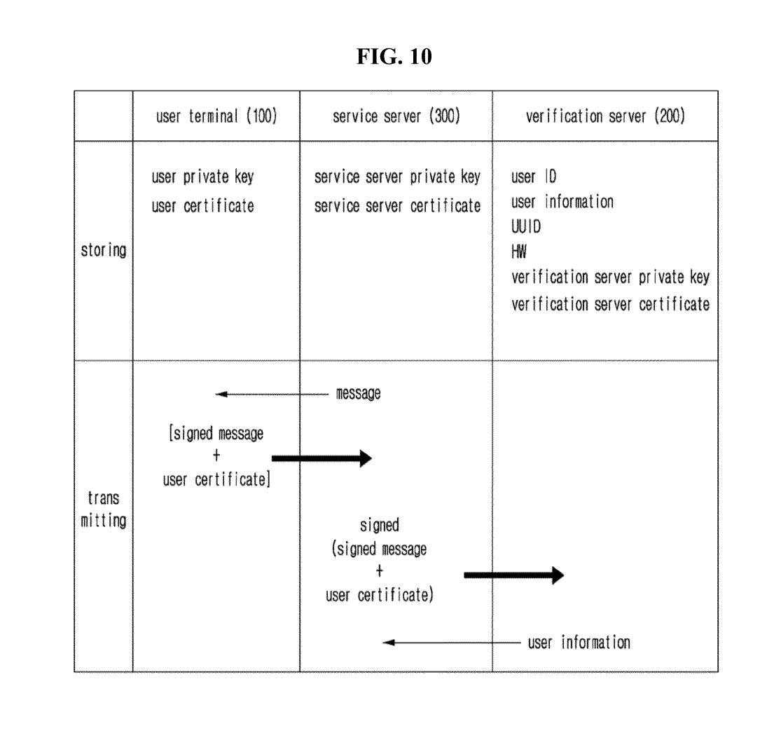

FIG. 10 is a table illustrating information transmitted or stored to each component during the process of verifying a user explained with reference to FIG. 4.

Referring to FIG. 10, the user terminal 100, verification server 200, and service server 300 always store their private key and certificate.

The user terminal 100 receives a message requiring a signature from the service server 300, and after signing a signature on the corresponding message, it is transmitted to the service server 300 together with the user certificate.

After signing all information transmitted from the user terminal 100, the service server 300 transmits it to the verification server 200 together with the service server certificate.

The verification server 200 validates the signature performed by the service server 300 through information transmitted from the service server 300, and validates the signature performed by the user terminal 100 through a symmetric key generated by itself. After completing all validation procedure, the service server 300 transmits user information to the service server 300.

The embodiments according to the present invention explained in the above may be recorded in a computer readable medium implemented in the form of program instructions that may be performed through various computer constituents. The computer readable medium may include a program instruction, data file, data structure, etc. alone or a combination thereof. The program instructions recorded in the computer readable medium may be those particularly designed and configured for the present invention, or those known to a person having ordinary skill in the field of computer software. Examples of computer readable medium may include magnetic media such as hard disk, floppy disk and magnetic tape, optical record media such as CD-ROM, DVD, magneto-optical media such as floptical disk, and hardware device particularly configured to store and perform program instructions such as ROM, RAM, flash memory, etc. Examples of program instructions include not only machine codes such as those made by a compiler, but also high-level codes that may be signed by a computer using an interpreter, etc. The hardware device may be configured to operate with at least one software module to perform the process according to the present invention, or vice versa.

Although the present invention has been described in terms of specific items such as detailed components as well as the limited embodiments and the drawings, they are only provided to help general understanding of the invention, and the present invention is not limited to the above embodiments. It will be appreciated by those skilled in the art that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method for issuing a user certificate of a verification server, comprising:
receiving a user certificate issue request including a user ID from a user terminal;
receiving a user public key, a biometric identification replacement code, and hardware identification information generated by the user terminal;
generating a user certificate including the user ID, the user public key, and certificate information; and
encrypting the generated user certificate and transmitting it to the user terminal.

2. The method of claim 1, wherein encrypting the user certificate is performed by encrypting a hash function value of the generated user certificate with a private key of the verification server.

3. The method of claim 1, wherein the biometric identification replacement code is a code replacing biometric information of a user recognized within the user terminal.

4. A method for being issued a user certificate of a user terminal, comprising:
transmitting a user certificate issue request including a user ID to a verification server;
generating a biometric identification replacement code by recognizing biometric information of a user when receiving an identification request from the verification server;
transmitting a user public key obtained after generating a pair of user keys, the biometric identification replacement code, and hardware identification information to the verification server; and
receiving a user certificate including the user ID, the user public key, and certificate information from the verification server.

5. A method for verifying a user at a user terminal, comprising:
receiving a message requiring an electronic signature from a service server;
generating a symmetric key based on the biometric information replacement code generated by recognizing biometric information of a user, hardware identification information and a time code;
performing a signature by encrypting the message through the symmetric key, and encrypting the message once again through a user private key generated at the time of issuing a user certificate; and
validating a signature on the message using a symmetric key generated at a verification server by transmitting the signed message and the user certificate to the service server.

6. The method of claim 5, wherein the step of validating the signature of the message comprises:
performing a signature by encrypting a user certificate received from the user terminal by the service server with a private key of the service server;
allowing the verification server to validate a signature on the user certificate with a public key of the service server confirmed through a certificate of the service server by transmitting signed the user certificate from the service server to the verification server together with a certificate of the service server; and
validating a signature on the message by allowing the service server to receive a symmetric key generated by the verification server.

7. The method of claim 6, wherein the symmetric key is generated by the verification server based on a user ID confirmed through the user certificate, and stored biometric information replacement code and time code stored matching with the user ID.

8. A method for verifying a user at a service server, comprising:
transmitting a message requiring an electronic signature to a user terminal;
receiving at a user terminal the message signed through a process of double encryption with a symmetric key and a user private key generated based on a biometric information replacement code, hardware identification code and time code together with a user certificate;
performing a signature by encrypting the user certificate with a private key of the service server;
allowing the verification server to receive a symmetric key generated based on a stored biometric information replacement code, hardware identification information and time code matching with a user ID included in the user certificate by transmitting the signed user certificate to a verification server; and
performing the signature validation of the signed message received from the user terminal using the symmetric key received.

9. The method of claim 8, wherein the step of receiving the symmetric key comprises allowing the verification server to validate a signature performed by the service server with a public key of a service server confirmed through a certificate of the service server by transmitting the signed user certificate and the certificate of the service server to a verification server.

10. A method for verifying a user at a verification server, comprising:
receiving the user certificate signed using a private key of a service server from the service server receiving the message signed through a symmetric key and user private key, and user certificate from a user terminal;
confirming a public key of a service server through a certificate of a service server received together with the signed user certificate, and performing the signature validation of the user certificate with the confirmed public key of the service server;
generating a symmetric key based on a stored biometric information replacement code, hardware identification information and time code matching with a user ID confirmed through the user certificate; and
performing the signature validation of the message by transmitting the generated symmetric key to the service server.
